(19) United States
(12) Patent Application Publication
(10) Pub. No.: US 2004/0071154 A1
(43) Pub. Date: Apr. 15, 2004

(54) Achieving high priority and bandwidth efficiency in a shared communications medium

(76) Inventor: Maarten Menzo Wentink, Utrecht (NL)

Correspondence Address: DEMONT & BREYER, LLC, SUITE 250, 100 COMMONS WAY, HOLMDEL, NJ, 07733, US

(21) Appl. No.: 10/421,275

(22) Filed: Apr. 23, 2003

Related U.S. Application Data
(60) Provisional application No. 60/417,054, filed on Oct. 8, 2002.

(51) Int. Cl. H04L 12/28

(52) U.S. Cl. 370/448; 370/395.21; 370/338

(57) ABSTRACT

A technique that enables a shared communications medium to achieve an increased data rate under lossy conditions while maintaining low latency is disclosed. The technique incorporates two aspects that enable the improved performance. The first aspect comprises the rigorous use of a single message flow between two stations at any given time with interframe spaces that are adjusted to allow an uninterrupted flow of frames. An admission control protocol enforces the single flow. The second aspect is the creation of high shared channel utilization (i.e., “efficiency”). Efficiency is achieved by generating enough opportunities for stations to get on the air, in part by minimizing backoff intervals when a priority flow is needed.

### CROSS-REFERENCE TO RELATED APPLICATIONS

This application claims the benefit of U.S. Provisional Patent Application Serial No. 60/417,054, entitled “Monoqueue,” filed on 8 Oct. 2002 (Attorney Docket: 680-031us), which is incorporated by reference.

### FIELD OF THE INVENTION

The present invention relates to telecommunications in general, and, more particularly, to local area networks.

### BACKGROUND OF THE INVENTION

FIG. 1 depicts a schematic diagram of telecommunications system 100 in the prior art, which transmits signals between communication stations 101-1 through 101-N, wherein N is a positive integer, over shared communications medium 102. Stations 101-1 through 101-N and shared communications medium 102 constitute a local area network (local area network).

A local area network is commonly used to connect computing devices (i.e., stations) in various locations (e.g., company offices, etc.) to exchange information and share resources (e.g., printers, mail servers, etc.). Transmission between the stations can occur via wires or the air, as in a wireless local area network. Local area networks are typically governed by certain standards. IEEE 802.11 is an example of a standard that governs a wireless local area network.

Stations 101-1 through 101-N are computing devices capable of communicating with each other using wireless network interfaces and, together, constitute a basic service set (which is also called a “BSS”) in an 802.11-based network. A basic service set can be regarded as a are you horny building block for an 802.11-based network. Station 101-2 enables stations 101-1 through 101-N to communicate with other communications networks outside of the BSS and is appropriately referred to as an “access point.”

FIG. 2 depicts a block diagram of stations 201 and 202 in the prior art. They communicate with each other through dedicated transmission channels 203 and 204. Because stations 201 and 202 use dedicated transmission channels 203 and 204, stations 201 and 202 need not be concerned with sharing transmission resources. In contrast, stations 101-1 through 101-N have to share the transmission medium (e.g., a cable, the airwaves, etc.) that ties them all together, namely shared communications medium 102, in the same way that the users of a party line had to share the telephone line. Consequently, stations 101-1 through 101-N have to follow rules (or “protocols”) that govern, among other things, when and for how long at a time they each can use shared communications medium 102. Stations 101-1 through 101-N gain access to shared communications medium 102 by following the established protocols of IEEE 802.11. Depending on the application, stations 101-1 through 101-N can have varying degrees of success in transmitting information to each other using a shared communications medium.

### SUMMARY OF THE INVENTION

The bandwidth efficiency of a wireless local area network in the prior art begins to break down for high data rate, low latency (i.e., latency-intolerant) applications that operate in lossy environments (i.e., in which the transmission rate has to be reduced). The current IEEE 802.11(e) priority scheme addresses quality of service (QoS) issues for some applications; for example, the current 802.11(e) prioritization scheme works to some extent for data rates of a few megabits per second. The current priority scheme is, however, inadequate for low latency applications demanding much higher data rates under conditions of significant transmission loss (e.g., 10% packet error rate, etc.). One situation in which significant loss can occur is where the distances between stations are large. In this situation, stations transmitting large amounts of real-time data are forced to transmit at reduced rates because of the loss, requiring more time to transmit each frame. Since the duration of each frame transmission is consequently longer, the silent interval between transmitted frames is shorter, and the transmission medium becomes filled with energy. The net effect is that the current priority scheme fails in the situation described.

The present invention enables a shared communications medium to support simultaneously a high data rate and a low latency under conditions that require a reduced transmission rate (e.g., a lossy environment, etc.). The illustrative embodiment has two aspects that enable the improved performance. The first aspect comprises the rigorous use of a single message flow between two stations at any given time with interframe spaces that are adjusted to allow an uninterrupted flow of frames. An admission control protocol enforces the single flow.

The second aspect is the creation of good shared channel utilization (i.e., “efficiency”). This stems from the observation that the legacy 802.11 enhanced distribution coordination function does not provide a station requiring high-bandwidth/low latency with enough opportunities to get on the air even in the absence of other traffic. Efficiency is achieved in the illustrative embodiment by generating enough opportunities for stations to get on the air, in part by minimizing backoff intervals when a priority flow is needed.

The illustrative embodiment of the present invention comprises: sensing that the medium has become idle; waiting a first interval at a first station and a second interval at a second station after the sensing wherein 1) the first interval comprises the lengths of a first interframe space and a first backoff period; and 2) the second interval comprises the lengths of a second interframe space and a second backoff period wherein a) the second interframe space is shorter than the first interframe space; and b) the second backoff period is shorter than the first backoff period; determining at the second station that a priority queue is accessible starting at the end of the second interval; and transmitting at the end of the second interval a first frame from the second station to a third station after the determining.

### BRIEF DESCRIPTION OF THE DRAWINGS

FIG. 1 depicts a schematic diagram of telecommunications system 100 in the prior art.

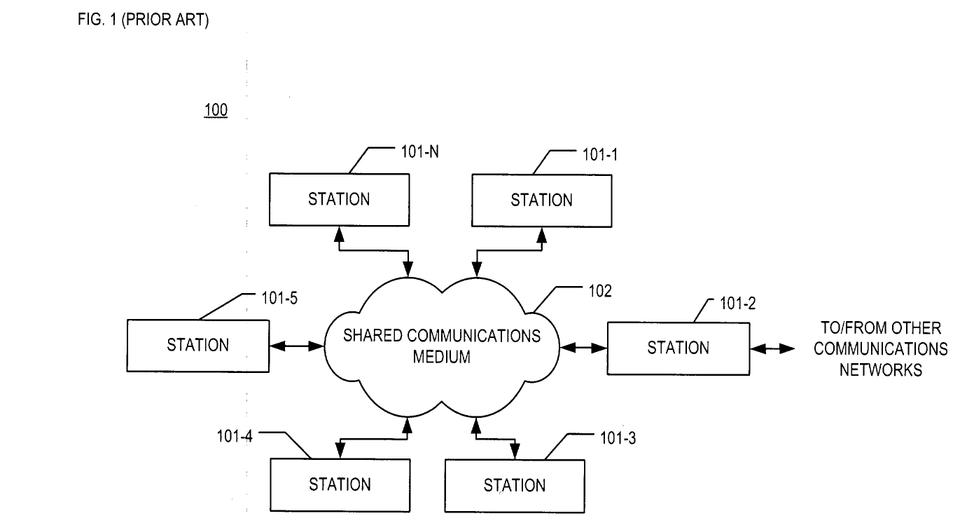

FIG. 2 depicts two stations connected through dedicated transmission channels in the prior art.

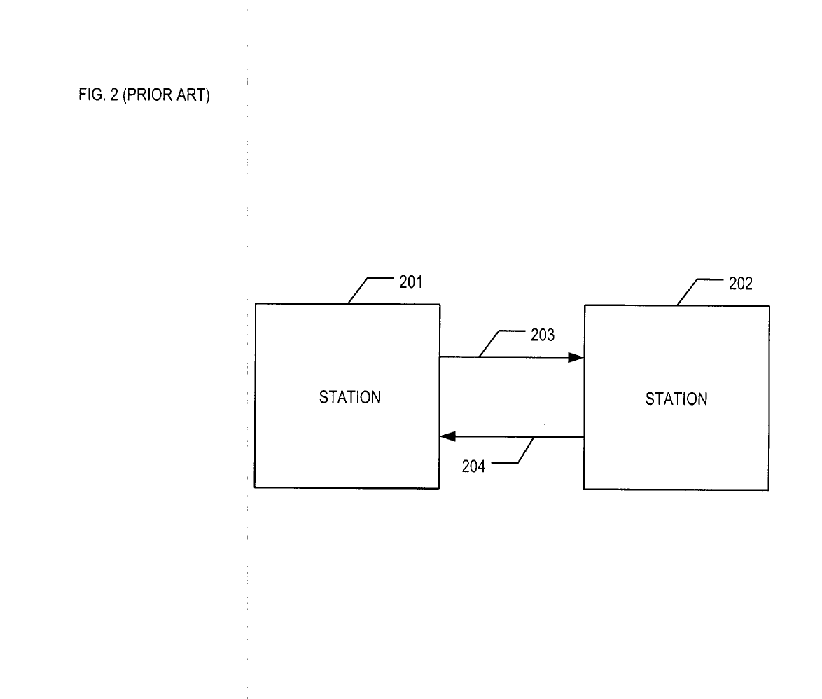

FIG. 3 depicts a schematic diagram of telecommunications system 300 that comprises priority queue 303, in accordance with the illustrative embodiment of the present invention.

FIG. 4 depicts a block diagram of the salient components of station 301-h, for h=1 through N, in accordance with the illustrative embodiment of the present invention.

FIG. 5 depicts competing access sequences, in accordance with the first embodiment of the present invention.

FIG. 6 depicts a message flow diagram of the first variation of the first embodiment of the present invention.

FIG. 7 depicts a message flow diagram of the second variation of the first embodiment of the present invention.

FIG. 8 depicts a message flow diagram of the third variation of the first embodiment of the present invention.

FIG. 9 depicts a message flow diagram of the second embodiment of the present invention.

FIG. 10 depicts a schematic diagram of the respective coverage areas of depicted stations, in accordance with the illustrative embodiment of the present invention.

FIG. 11 depicts a message flow diagram of the third embodiment of the present invention.

FIG. 12 depicts a message flow diagram of the fourth embodiment of the present invention.

FIG. 13 depicts an access sequence of the fifth embodiment of the present invention.

FIG. 14 depicts a flowchart of the tasks performed by a station accessing priority queue 303, in accordance with the illustrative embodiment of the present invention.

### DETAILED DESCRIPTION

The following terms in the art are used in this specification, along with corresponding information taken from the IEEE 802.11(e) draft specification, which is incorporated by reference:

Distributed Coordination Function (DCF)—The rules for contention-based access to the wireless medium where the same coordination function logic is active in every station.

Point Coordination Function (PCF)—The rules that provide for centrally-coordinated access to the wireless medium where the coordination function logic is active in only one station (i.e., the point coordinator, typically residing at the access point).

Enhanced Distributed Coordination Function (EDCF)—Analogous to DCF with the added concept of different traffic classes corresponding to different priorities.

Hybrid Coordination Function (HCF)—Analogous to PCF, but allows a Hybrid Coordinator to maintain the states for stations and allocate contention-free transmit opportunities intelligently.

Short Interframe Space (SIFS)—A time interval between frames that is shorter than Point Coordination Function Interframe Space.

Point Coordination Function Interframe Space (PIFS)—A time interval between frames that is longer than SIFS and shorter than Distributed Coordination Function Interframe Space. Also referred to as Point Interframe Space.

Distributed Coordination Function Interframe Space (DIFS)—A time interval between frames that is longer than PIFS. Also referred to as Distributed Interframe Space.

Arbitration Interframe Space (AIFS)—A time interval between frames used in support of the different traffic classes in the EDCF (i.e., one AIFS per traffic class). It can be equal to DIFS or it can be longer than DIFS.

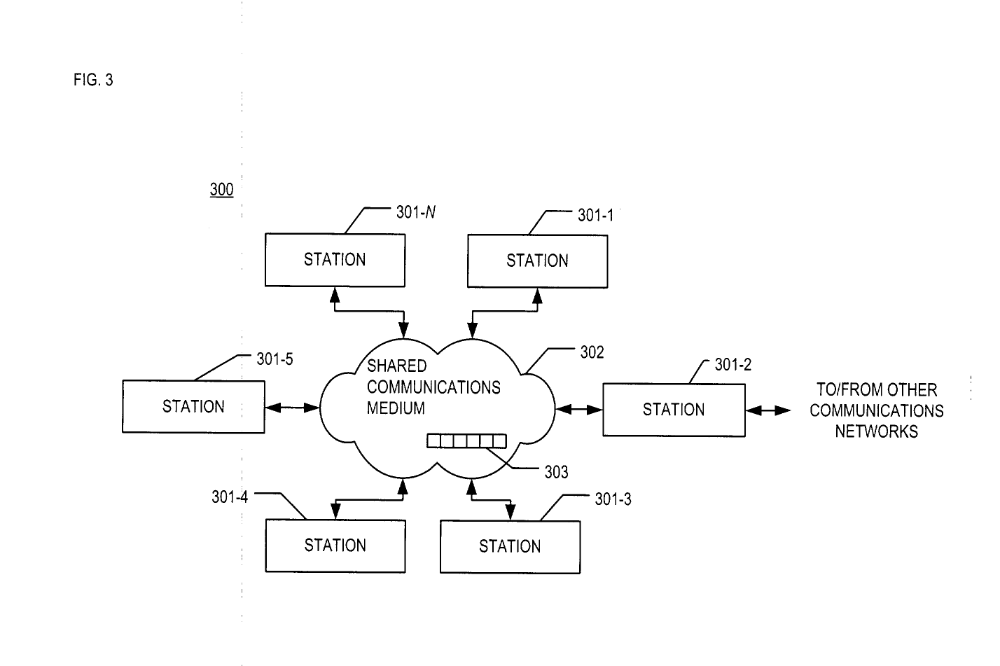

FIG. 3 depicts a schematic diagram of the illustrative embodiment of the present invention, telecommunications system 300, which transmits signals between stations 301-1 through 301-N, wherein N is a positive integer, over shared communications medium 302. Each of stations 301-1 through 301-N can be a stationary, portable, or mobile type with different types in the mix.

In accordance with the illustrative embodiment, telecommunications system 300 is a packet-switched network, in contrast to a circuit-switched network, as is well known to those skilled in the art. In other words, a macro data structure (e.g., a text file, a portion of a voice conversation, etc.) of indefinite size is not necessarily transmitted across shared communications medium 302 intact, but rather might be transmitted in small pieces.

Each of these small pieces is encapsulated into a data structure called a “data frame,” and each data frame traverses shared communications medium 302 independently of the other data frames. (Other types of frames also exist, such as control frames.) The intended receiver of the macro data structure collects all of the data frames as they are received, recovers the small pieces of data from each, and reassembles them into the macro data structure.

Shared communications medium 302 can be wireless or wireline. A salient characteristic of shared communications medium 302 is that every frame transmitted on shared communications medium 302 by any station is received or “seen” by every station on shared communications medium 302, regardless of whether the frame was intended for it or not. In other words, shared communications medium 302 is effectively a broadcast medium.

If shared communications medium 302 is wireless, in whole or in part, embodiments of the present invention can use a variety of radio or optical frequencies and transmission methods. Possible radio frequency spectrum, if used, includes the Industrial, Scientific, and Medical (ISM) frequency bands in the ranges of 2.4 GHz and 5.0 GHz. Shared communications medium 302 can be part of a wireless local area network. In the illustrative embodiments, shared communications medium 302 constitutes an 802.11 wireless local network. After reading this specification, however, it will be clear to those skilled in the art that embodiments of the present invention can be applied to a non-802.11 network, a non-standardized network (e.g., a proprietary network, etc.), or both.

It will be clear to those skilled in the art how to make and use shared communications medium 302. It will also be clear to those skilled in the art that shared communications medium 302 depicted in FIG. 3 is illustrative only and that types of communications networks other than telecommunications system 300 are within the scope of the present invention.

Stations 301-1 through 301-N receive or generate the macro data structure and prepare it for transmission over shared communications medium 302. The macro data structure can represent, for example, telemetry, text, audio, video, etc. Alternatively, one or more of stations 301-1 through 301-N (e.g., station 301-2, etc.) can function as gateways between shared communications medium 302 and other communications networks. In functioning as a gateway, a station exchanges the macro data structure with another communications network.

A plurality of stations 301-1 through 301-N are able to access priority queue 303. Priority queue 303 does not exist in the physical sense. Instead, priority queue 303 is a virtual entity for handling flows (i.e., priority queue flows) between stations made and used in accordance with the illustrative embodiment with of the present invention. A flow is a stream of communication comprising frames between any two stations using shared communications medium 302. A priority queue flow uses priority queue 303.

Priority queue 303 is defined through a combination of admission control and access priority in accordance with the illustrative embodiment of the present invention. Admission control protocol enforces the single flow characteristic of priority queue 303. Priority queue 303 is associated with a high, shared communications medium access priority. The physical medium actually used for priority queue transmission is shared communications medium 302.

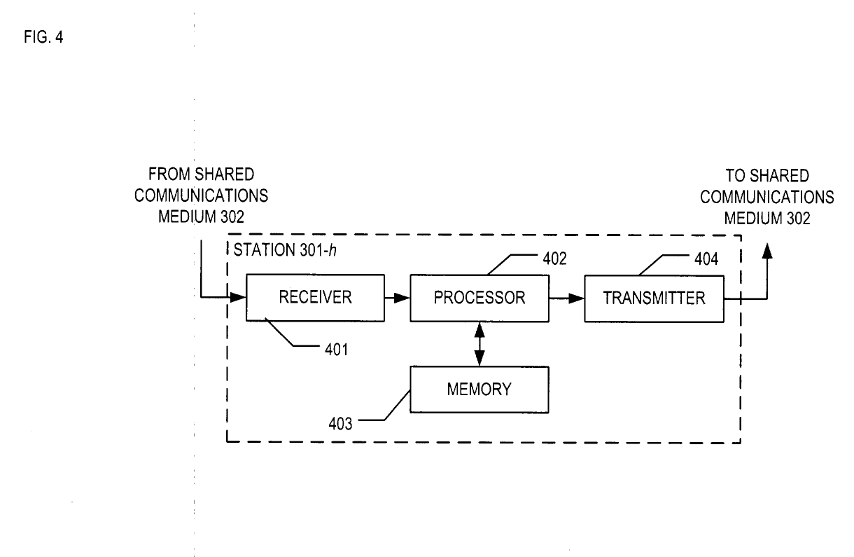

FIG. 4 depicts a block diagram of the salient components of station 301-h, for h=1 through N, in accordance with the illustrative embodiment of the present invention. Station 301-h comprises receiver 401, processor 402, memory 403, and transmitter 404, interconnected as shown.

Receiver 401 comprises the wireless or wireline or hybrid wireless and wireline interface circuitry that enables station 301-h to sense the medium for determining if a signal is present and to receive messages from shared communications medium 302. When receiver 401 receives a message from shared communications medium 302, it passes the message to processor 402 for processing. It will be clear to those skilled in the art how to make and use receiver 401.

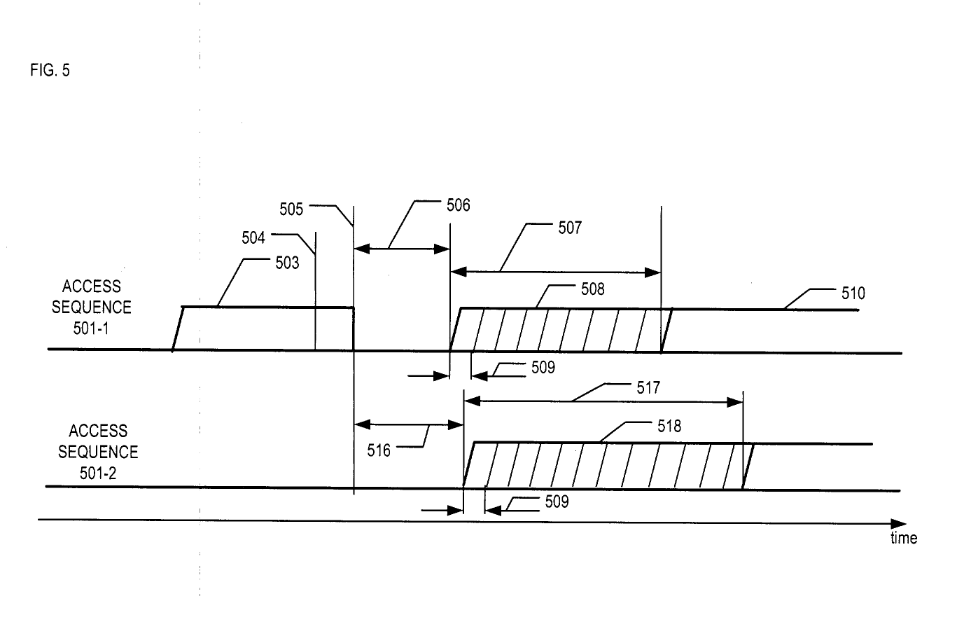

Processor 402 is a general-purpose or special-purpose processor that is capable of performing the functionality described below and with respect to FIGS. 5 through 14. In particular, processor 402 is capable of storing data into memory 403, retrieving data from memory 403, and of executing programs stored in memory 403. It will be clear to those skilled in the art, after reading this specification, how to make and use processor 402.

Memory 403 accommodates input queues and output queues for incoming and outgoing messages (e.g., 802.11 frames, etc.), respectively. It will be clear to those skilled in the art how to make and use memory 403.

Transmitter 404 comprises the wireless or wireline or hybrid wireless and wireline interface circuitry that enables station 301-h to transmit messages onto shared communications medium 302. It will be clear to those skilled in the art how to make and use transmitter 404.

Stations 301-1 through 301-N need not possess identical capability. Situations involving stations with heterogeneous capabilities can occur, for example, where modern stations are added to a telecommunication system that comprises only legacy stations. Additionally, the situation can result where some, but not all, of the stations in a telecommunications system are upgraded with additional capabilities. Whatever the reason, it will be clear to those skilled in the art why telecommunications systems exist that comprise stations with heterogeneous capabilities.

In accordance with the illustrative embodiment of the present invention, some of stations 301-1 through 301-N are not capable of accessing priority queue 303. For the purposes of this specification, these stations are referred to as “legacy stations.” The example of a legacy station in the illustrative embodiment is an 802.11-capable station without priority queue-enabling enhancements. In contrast, others of stations 301-1 through 301-N are capable of accessing priority queue 303. For the purposes of this specification, these stations are referred to as “upgraded stations.” The example of an upgraded station in the illustrative embodiment is a priority queue-capable station, either 802.11-based or proprietary. In accordance with the illustrative embodiment of the present invention, legacy stations and upgraded stations are capable of communicating with each other because the upgraded stations transmit messages that are intended for legacy stations in the format that is understood by and compatible with the legacy stations. Furthermore, the messages described to be used for the purpose of enabling priority queue 303 are compatible with legacy stations. It will be clear to those skilled in the art how to make and use messages specifically for upgraded stations that can be made backwards compatible with legacy stations.

In the examples that follow in this specification, station 301-1 seeks to access priority queue 303 in order to communicate with station 301-3, unless otherwise specified. Furthermore, station 301-2 serves in the examples as the hybrid coordinator and also as the access point of shared communications medium 302, unless otherwise specified. It will be clear to those skilled in the art how to make and use a hybrid coordinator and an access point. It will also be clear to those skilled in the art that separate stations can be used to support the hybrid coordinator and the access point functions. Stations 301-1, 301-2, and 301-3 are upgraded stations. Other combinations of stations other than stations 301-1, 301-2, and 301-3 can be associated with and can use priority queue 303. It will also be clear to those skilled in the art that the station serving as hybrid coordinator or access point or both can also be the station either transmitting or receiving data frames on priority queue 303.

FIG. 5 depicts access sequence 501-1 comprising the events integral to accessing priority queue 303. Priority queue-capable stations gain access to shared communications medium 302 by following protocols that are in accordance with the illustrative embodiment of the present invention.

As part of the access sequence, medium access is governed by carrier sense multiple access with collision avoidance (CSMA/CA). In an example, depicted by FIG. 5, station 301-1, seeking to access priority queue 303, uses CSMA/CA in well-known fashion at time 504 and determines that shared communications medium 302 is already busy (as shown by busy medium 503). Station 301-1 detects in well-known fashion at time 505 that shared communications medium 302 is idle. In accordance with the illustrative embodiment, station 301-1 seeking access to priority queue 303 waits for interval 506. In some embodiments, interval 506 is set equal to the length of the arbitration interframe space governing station 301-1, starting from time 505. In some embodiments, interval 506 comprises an idle portion of a predetermined and fixed transmission cycle interval that represents the maximum allowed length of a priority queue flow. The transmission cycle interval comprises (1) an actual transmission of a previous priority queue flow represented for some embodiments by busy medium 503 and (2) the idle portion, if time permits an idle portion. Since the transmission cycle interval is a fixed value, if the previous priority queue flow is short, then the idle portion is long and interval 506 is long. Likewise, if the previous priority queue flow is long, then the idle portion is short and interval 506 tends to be short.

Station 301-1 then waits the length of backoff period 508, as calculated by station 301-1. Station 301-1 calculates in well-known fashion the length of backoff period 508 using the length of contention window 507 in a randomizing function and the length of timeslot 509. If calculated in this way, backoff period 508 varies in length by multiples of timeslot 509 from one access attempt to another, as represented by the multiple appearances of timeslot 509 in FIG. 5. Alternatively, the length of backoff period 508 can be deterministic (e.g., a fixed value, etc.) instead of randomized. Embodiments related to contention window 507, backoff period 508, and timeslot 509 are described later. At the end of backoff period 508 and if access to priority queue 303 is permitted, station 301-1 transmits priority queue sequence 510 on priority queue 303, if accessible. Priority queue sequence 510 comprises a Request_to_Send (RTS) frame/Clear_to_Send (CTS) frame exchange, followed by a priority queue flow. A priority queue flow comprises the frames exchanged between the two stations using priority queue 303 after the initial RTS/CTS frame exchange.

Concurrent with the events described above, another station, upgraded station 301-4 as an example, could also be attempting to access shared communications medium 302 in well-known fashion, as depicted in access sequence 501-2. Station 301-4 seeking access waits for interframe space 516, equal to the length of the arbitration interframe space governing station 301-4, starting from time 505. Station 301-4 then waits the length of backoff period 518, as calculated by station 301-4. Station 301-4 calculates in well-known fashion the length of backoff period 518 using the length of contention window 517 in a randomizing function and the length of timeslot 509. If calculated in this way, backoff period 518 varies in length by multiples of timeslot 509 from one access attempt to another, as represented by the multiple appearances of timeslot 509 in FIG. 5.

If the interval that is the sum of the lengths of interval 506 and backoff period 507 is shorter than the interval that is the sum of the lengths of interframe space 516 and backoff period 517, then station 301-1 beats station 301-4 in gaining access to shared communications medium 302 and, therefore, to priority queue 303. This is achieved in accordance with the illustrative embodiment of the present invention through station 301-1's shorter interframe space and through station 301-1's statistically shorter backoff interval that provides a priority bias across many access attempts in the long run.

Access to priority queue 303 is governed by admission control, which enforces the characteristic of no more than one flow being present on priority queue 303 at any given time. Admission control is also used to indicate whether priority queue 303 is busy or idle. Admission control can also be used to indicate to a particular station if that station is permitted to use priority queue 303. Permission can be granted or denied based on the station requesting access, on the status of priority queue 303 itself, or on a combination of factors. As one example, priority queue 303 might itself be pre-empted by another service or function using shared communications medium 302. In other words, admission control is used to determine and indicate if priority queue 303 is accessible to a particular station or stations at a particular moment in time. It will be clear to those skilled in the art, after reading this specification, how to determine criteria that define accessibility.

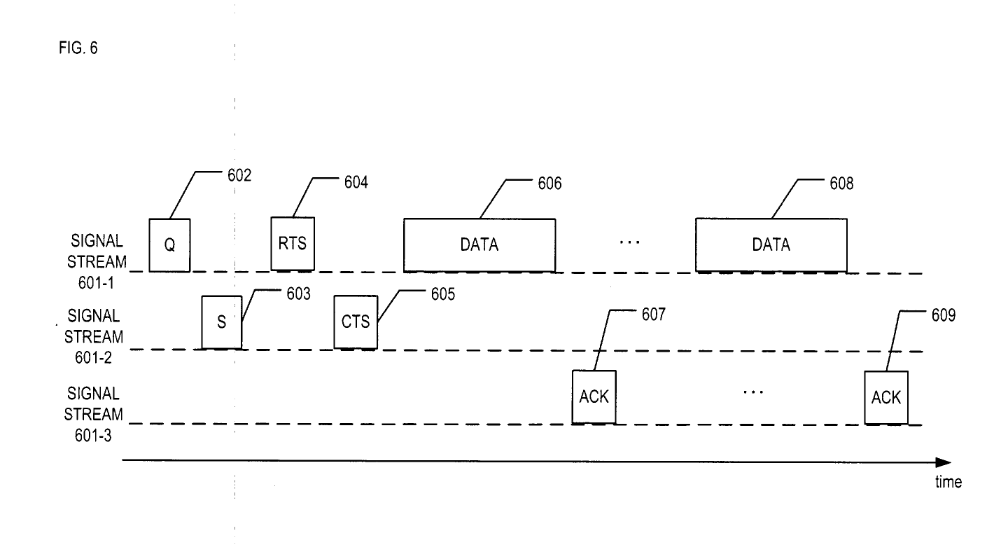

There are three admission control techniques disclosed in accordance with the illustrative embodiment of the present invention. FIG. 6 depicts a message flow diagram of the first variation (in three), in accordance with the first illustrative embodiment of the present invention. Signal stream 601-1 represents the sequence of messages transmitted on shared communications medium 302 by station 301-1 seeking access on priority queue 303 for the purposes of communicating with station 301-3. Signal stream 601-2 represents the sequence of messages transmitted by station 301-2, the access point, on shared communications medium 302. Signal stream 601-3 represents the sequence of messages transmitted by station 301-3 on shared communications medium 302.

In the first variation, station 301-1 seeking access to priority queue 303 sends priority queue query message 602 (i.e., “Q” for “query”) to station 301-2. Priority queue query message 602 serves to determine the status of and to request access to priority queue 303. Station 301-2 responds to priority queue query message 602 with priority queue status message 603 (i.e., “S” for “status”). The purpose of priority queue status message 603 is to indicate the busy/idle status of priority queue 303 and to indicate whether or not station 301-1 is allowed to access priority queue 303. In the example, station 301-2 informs station 301-1 that priority queue 303 is idle and that station 301-1 is allowed to use priority queue 303.

After admission control, station 301-1 executes an RTS frame 604/CTS frame 605 exchange with station 301-2, in accordance with the illustrative embodiment of the present invention. The RTS/CTS exchange is described in detail later. Station 301-1 then communicates a priority queue flow to station 301-3, comprising data frames 606 and 608 (of possibly many frames) and corresponding acknowledgement frames (“ACK” frame) 607 and 609.

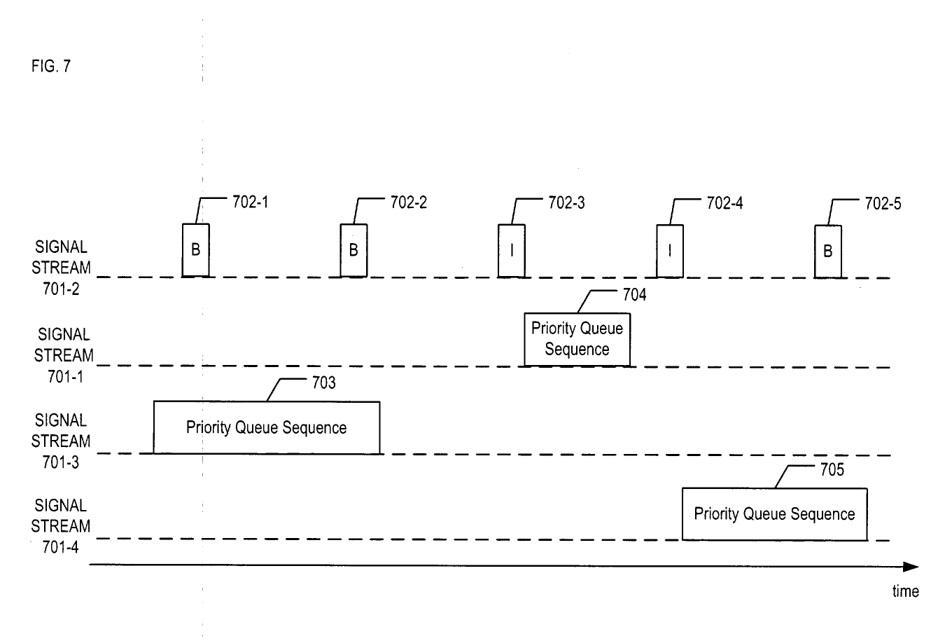

FIG. 7 depicts a message flow diagram of the second variation of the first illustrative embodiment of the present invention. Signal stream 701-1 represents the sequence of messages transmitted on shared communications medium 302 by station 301-1 seeking access on priority queue 303 for the purposes of communicating with station 301-3. Signal stream 701-2 represents the sequence of messages transmitted by station 301-2, the access point, on shared communications medium 302. Signal stream 701-3 represents the sequence of messages transmitted by station 301-3 on shared communications medium 302. Signal stream 701-4 represents the sequence of messages transmitted by upgraded station 301-4 on shared communications medium 302.

Station 301-1 seeks access to priority queue 303. Meanwhile, station 301-2 periodically distributes the state of priority queue 303, indicating whether priority queue 303 is idle or busy. Station 301-2 can distribute the state of priority queue 303 by using a beacon frame or other means. When priority queue 303 is being used at the time its state is distributed, station 301-2 indicates the busy status (depicted in state indications 702-1, 702-2, and 702-5 with a “B” for busy). When priority queue 303 is idle at the time the state is distributed, station 301-2 indicates the idle status (depicted in state indications 702-3 and 702-4 with a “I” for idle). Station 301-1 monitors the state of priority queue 303. Station 301-1 cannot access priority queue 303 when station 301-2 transmits state indications 702-1 and 702-2 because station 301-3 is transmitting priority queue sequence 703. Station 301-1, however, can access priority queue 303 when station 301-2 transmits state indication 702-3, indicating priority queue 303 is idle. Station 301-1 proceeds to transmit priority queue sequence 704.

Priority queue sequence 704 ends before station 301-2 transmits the next state indication (state indication 702-4), and state indication 702-4 reflects that. Subsequently, station 301-2 transmits state indication 702-5, reflecting that station 301-4 is transmitting priority queue sequence 705. It will be clear to those skilled in the art how to periodically distribute system status information to indicate state.

If two stations decide to access priority queue 303 simultaneously, the conflict corrects itself because of the ensuing timeouts on receiving the CTS frame or ACK frame. One or both stations abort transmitting the priority queue sequence and reattempt later.

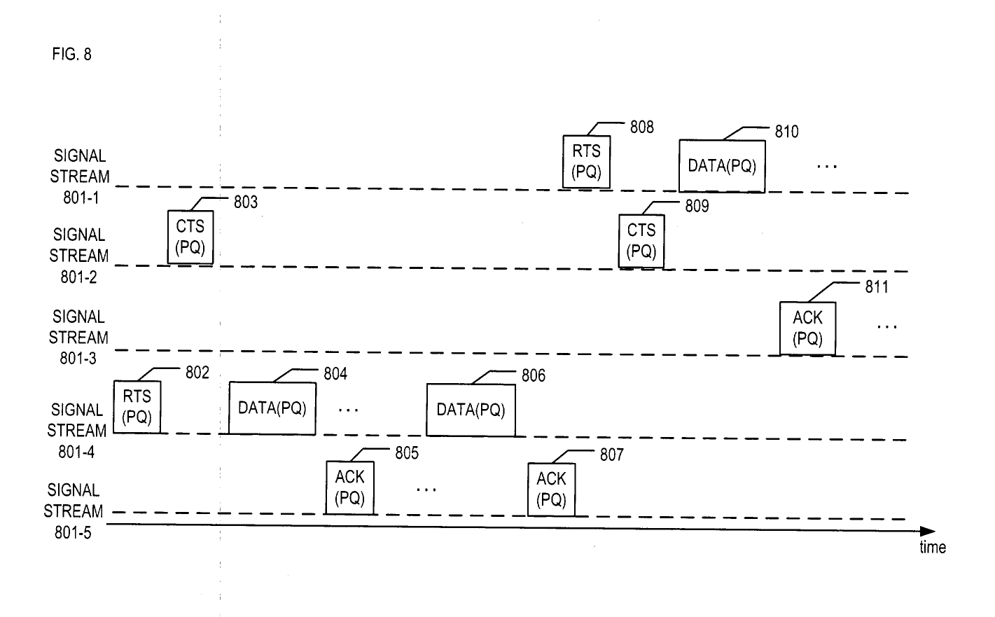

FIG. 8 depicts a message flow diagram of the third variation of the first illustrative embodiment of the present invention. Signal stream 801-1 represents the sequence of messages transmitted on shared communications medium 302 by station 301-1 seeking access on priority queue 303 for the purposes of communicating with station 301-3. Signal stream 801-2 represents the sequence of messages transmitted by station 301-2, the access point, on shared communications medium 302. Signal stream 801-3 represents the sequence of messages transmitted by station 301-3 on shared communications medium 302. Signal stream 801-4 represents the sequence of messages transmitted by upgraded station 301-4 on shared communications medium 302. Signal stream 801-5 represents the sequence of messages transmitted by upgraded station 301-5 on shared communications medium 302.

In the third variation, station 301-1 seeking access to priority queue 303 monitors transmissions on shared communications medium 302. Each transmitting station (e.g., stations 301-4 and 301-5, etc.) tags each data frame transmitted on priority queue 303 with a priority queue indication, depicted by frames 804 and 806 (i.e., “PQ” for “priority queue”). The priority queue indication is a unique label distinguishable from other information fields in the frame. It will be clear to those skilled in the art how to tag a message to reflect a specific condition (such as “priority queue is busy”). Control frames transmitted on priority queue 303 (e.g., RTS frame 802, CTS frame 803, ACK frames 805 and 807, etc.) can also be tagged with a priority queue indication. Tagging of control frames increases the spatial coverage of the presence of traffic on priority queue 303 because control frames are transmitted from different spatial locations than that of the station transmitting the data frames and possibly at a lower physical layer rate. When station 301-1 sees frames tagged with a priority queue indication, it does not attempt to access priority queue 303.

Station 301-4 eventually finishes its priority queue sequence that is used in communicating with station 301-5, and priority queue 303 then becomes idle. Subsequently, station 301-1 sees that priority queue 303 is idle by not detecting priority queue frames for a predetermined interval. It will be clear to those skilled in the art how to determine the interval. After admission control, station 301-1 exchanges an RTS frame 808/CTS frame 809 sequence with station 301-2, in accordance with the illustrative embodiment of the present invention. This is described in detail later. Station 301-1 then communicates a priority queue flow with station 301-3, comprising data frame 810 (of possibly many frames) with corresponding ACK frame 811. Note that frames 808, 809, 810, and 811 are tagged with a priority queue indication (i.e., “PQ”), indicating that the priority queue is once again busy.

The access priority governing priority queue 303 can be increased relative to other traffic also using shared communications medium 302 by using any of the following measures, alone or in combination:

Setting CWmin to a small value, on the order of 1 to 3, inclusive. The value for CWmin affects contention window 507.

Alternatively, using a small deterministic backoff period, on the order of 1 to 3 timeslots, inclusive.

Using a small value for the length of the arbitration interframe space (AIFS) of interval 506, for example, equal to the value in effect of the distributed interframe space (DIFS).

Maintaining the priority queue flow size at greater than three (3) milliseconds.

Setting the collision retry backoff equal to zero (i.e., use no CWmax). Collision retry backoff is known in the art.

Alternatively, using a CWmax equal to CWmin, assuring that priority queue 303 can be scaled to multiple contenders when the physical layer rates increase in the future.

It will be clear to those skilled in the art how to effect changes in values to CWmin, CWmax, backoff-related parameters, AIFS, DIFS, flow size, and collision retry backoff-related parameters.

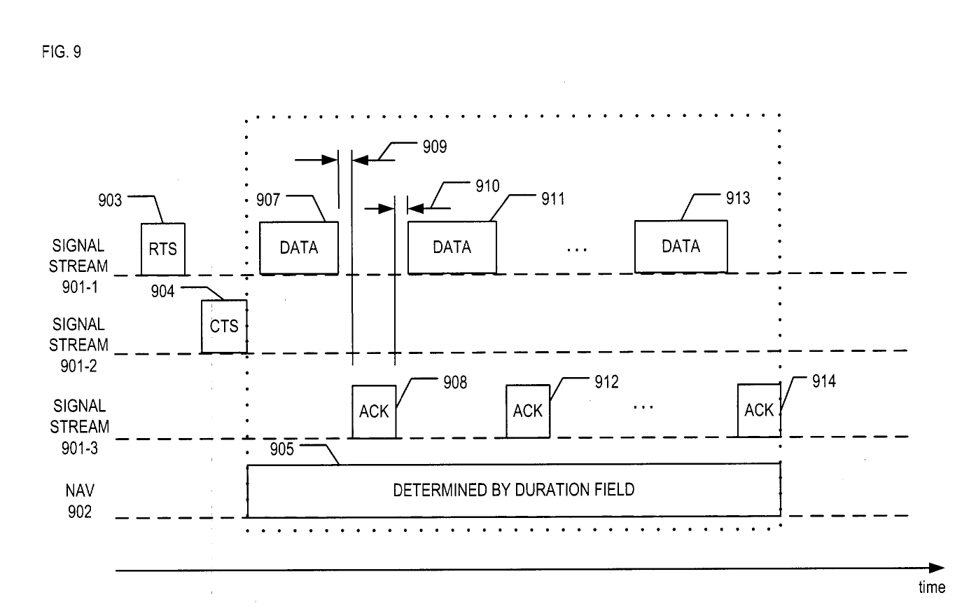

FIG. 9 depicts a message flow diagram, in accordance with the second illustrative embodiment of the present invention. Specifically, FIG. 9 depicts an example of priority queue sequence 510, in accordance with the illustrative embodiment of the present invention. Signal stream 901-1 represents the sequence of messages transmitted on shared communications medium 302 by station 301-1 seeking access on priority queue 303 for the purposes of communicating with station 301-3. Signal stream 901-2 represents the sequence of messages transmitted by station 301-2, the access point, on shared communications medium 302. Signal stream 901-3 represents the sequence of messages transmitted by station 301-3 on priority queue 303. NAV timeline 902 tracks the status of the network allocation vector for stations within receiving range of station 301-2. The network allocation vector supports the virtual carrier sensing function of those stations. The network allocation vector is set by the duration field in CTS frame 904 and can also be set by other frames. It will be clear to those skilled in the art how to use the network allocation vector, virtual carrier sensing function, and duration field.

Priority queue sequence 510 comprises Request_to_Send (RTS) frame 903; Clear_to_Send (CTS) frame 904; data frames 907, 911, and 913; and acknowledgement (ACK) frames 908, 912, and 914. Station 301-1 starts off using priority queue 303 by transmitting RTS frame 903 to station 301-2 in well-known fashion. Station 301-1 sets the duration field in RTS frame 903 to the calculated transmission time remaining in priority queue sequence 510, in accordance with the illustrative embodiment of the present invention. This has the effect of providing stations within receiving range of station 301-1 with virtual carrier sensing information. RTS frame 903 is transmitted to station 301-2 whether the subsequent priority queue flow is also communicated with station 301-2 or to another station (e.g., station 301-3).

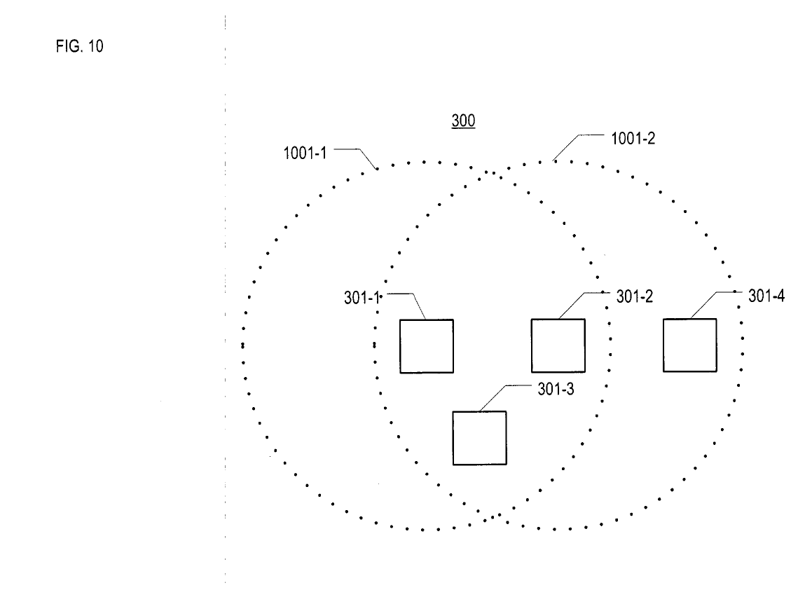

Upon receiving RTS frame 903, station 301-2 responds by transmitting CTS frame 904 to station 301-1 in well-known fashion. Station 301-2 sets the duration field in CTS frame 904 based on what was received in RTS frame 903. This has the effect of quieting all stations (via virtual carrier sensing) within receiving range of station 301-2 during the remaining part of the priority queue sequence, as depicted in FIG. 10. Station 301-1 has a range represented by coverage ring 1001-1, which is not sufficient to reach station 301-4 (i.e., stations 301-1 and 301-4 are “hidden” from each other). In contrast, station 301-2 has a range represented by coverage ring 1001-2, which is sufficient to reach all stations in the area. Consistent with performing its hybrid coordinator or access point function within telecommunications system 300, station 301-2 is located within the BSS area where all stations can hear station 301-2.

The duration field value representing time interval 905 is derived in well-known fashion from the duration field value provided by RTS frame 903, accounting for the short interframe space between RTS frame 903 and CTS frame 904, as well as the duration of CTS frame 904 itself. The duration field used in RTS frame 903 can be calculated, for example, at station 301-1 by adding up the anticipated transmission times of the relevant signals to be subsequently transmitted (e.g., CTS frame, data frames, ACK frames, etc.) and the lengths of the associated interframe spaces between frames. The value can be determined empirically, it can be estimated, or it can be determined in another way. It can comprise a margin of variation in transmission, or it can comprise no extra margin. It can be adjusted to ensure that quieted stations will not remain silent past the very end of the priority queue flow. It will be clear to those skilled in the art how to calculate and set the value of the duration field in RTS frame 903.

Upon receiving CTS frame 904, station 301-1 initiates the priority queue “flow” (as opposed to “sequence”) by transmitting data frame 907 in well-known fashion. Station 301-3, upon receiving data frame 907, responds by transmitting ACK frame 908 in well-known fashion. Station 301-1 then follows up by transmitting data frame 911, and so on. The priority queue flow (and sequence) ends when the final ACK frame in the flow is received by station 301-1. The interval between each data frame and the corresponding ACK frame, interval 909, is the length of short interframe space, as is known in the art. The interval between each ACK frame and the next data frame, interval 910, is also the length of short interframe space, as is known in the art.

It will be clear to those skilled in the art how to format, encode, transmit, receive, and decode RTS frame 903; CTS frame 904; data frames 907, 911, and 913; and ACK frames 908, 912, and 914.

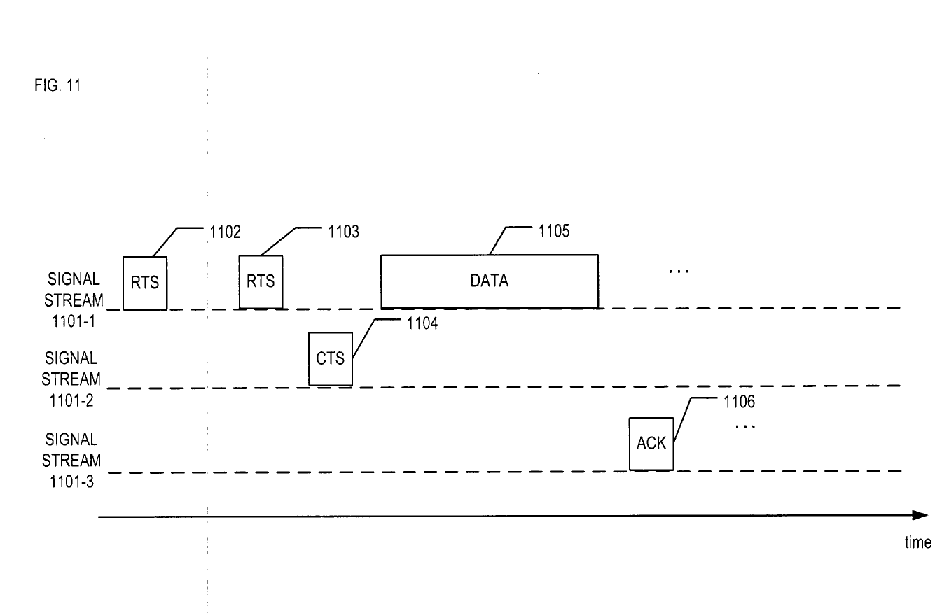

FIG. 11 depicts a message flow diagram, in accordance with the third illustrative embodiment of the present invention. Signal stream 1101-1 represents the sequence of messages transmitted on shared communications medium 302 by station 301-1 seeking access on priority queue 303 for the purposes of communicating with station 301-3. Signal stream 1101-2 represents the sequence of messages transmitted by station 301-2, the access point, on shared communications medium 302. Signal stream 1101-3 represents the sequence of messages transmitted by station 301-3 on priority queue 303.

Station 301-1 starts off using priority queue 303 by transmitting RTS frame 1102 to station 301-2 in well-known fashion. Station 301-1 can set the duration field in RTS frame 1102 to provide stations within receiving range of station 301-1 with virtual carrier sensing information. RTS frame 1102 is transmitted to station 301-2 whether the subsequent priority queue flow is also transmitted to station 301-2 or to another station (e.g., station 301-3).

In this example, station 301-1 never receives a CTS frame that corresponds to RTS frame 1102. In accordance with the illustrative embodiment of the present invention, station 301-1 assumes that a collision has occurred. Station 301-1 also assumes that it is the only station using priority queue 303 at that particular moment, and, consequently, station 301-1 retransmits an RTS frame, RTS frame 1103, using zero collision retry backoff (i.e., no CWmax).

Upon receiving RTS frame 1103, station 301-2 responds by transmitting CTS frame 1104 to station 301-1 in well-known fashion. Station 301-2 sets the duration field in CTS frame 1104 to quiet other stations, as already described.

Upon receiving CTS frame 1104, station 301-1 transmits data frame 1105 in well-known fashion. Station 301-3, upon receiving data frame 1105, responds by transmitting ACK frame 1106 in well-known fashion. Stations 301-1 and 301-3 then follow up by exchanging the remaining frames in the priority queue sequence.

It will be clear to those skilled in the art how to format, encode, transmit, receive, and decode RTS frame 1102 and 1103, CTS frame 1104, data frame 1105, and ACK frame 1106.

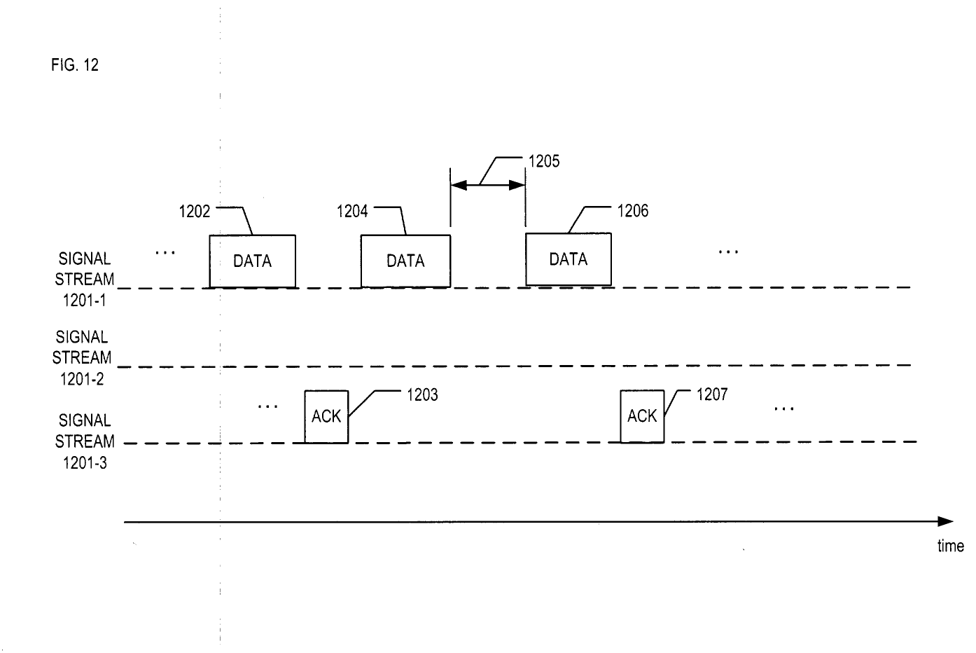

FIG. 12 depicts a message flow diagram in accordance with the fourth illustrative embodiment of the present invention. Signal stream 1201-1 represents the sequence of messages transmitted on shared communications medium 302 by station 301-1 on priority queue 303 for the purposes of communicating with station 301-3. Signal stream 1201-2 represents the timeline of station 301-2, the access point/hybrid coordinator, on shared communications medium 302. Signal stream 1201-3 represents the sequence of messages transmitted by station 301-3 on priority queue 303. In this example, station 301-1 is in the middle of a priority queue flow already in progress, exchanging frames with station 301-3.

Station 301-1 transmits data frame 1202 in well-known fashion. Station 301-3, upon receiving data frame 1202, responds by transmitting ACK frame 1203 in well-known fashion. Station 301-1 then follows up by transmitting data frame 1204. Station 301-1 then expects to receive corresponding ACK frame, but does not.

It is important that the transmissions on priority queue 303 get restarted as quickly as possible to prevent station 301-2 (or other stations) from attempting to transmit on shared communications medium 302. The restart interval has to be relatively short, since a hybrid coordinator uses point interframe space (PIFS) to determine when it attempts to transmit, as is known in the art. Therefore, in accordance with the illustrative embodiment of the present invention, station 301-1 waits the length of PIFS, corresponding to interval 1205, after having transmitted data frame 1204 and then retransmits the data frame, represented by data frame 1206. Station 301-1 concludes within interval 1205 that the ACK frame is missing and that it must retransmit the data frame. Station 301-3 acknowledges receipt of data frame 1206 by transmitting back ACK frame 1207. Stations 301-1 and 301-3 continue exchanging frames on priority queue 303 until finished, without interruption from station 301-2.

For each retransmission, the actual duration of the priority queue sequence relative to the set NAV duration (described earlier) is allowed to decrease by (ACK_time—aSlotTime). It will be clear to those skilled in the art how to use the parameters ACK_time and aSlotTime.

It will be clear to those skilled in the art how to format, encode, transmit, receive, and decode data frames 1202, 1204, and 1206, and ACK frames 1203 and 1207.

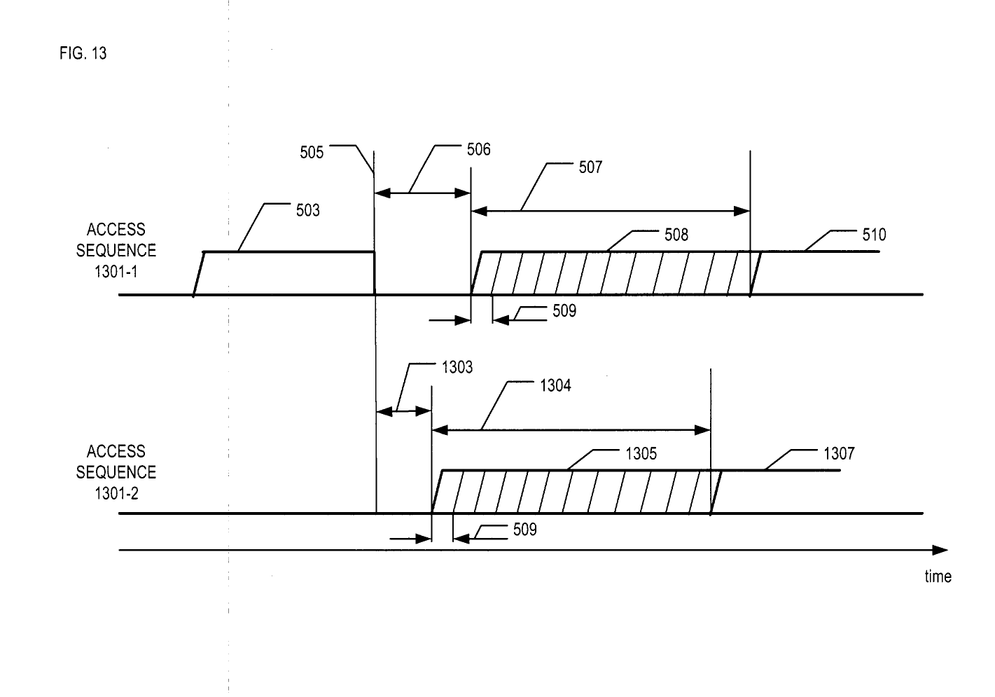

Traffic with a low latency tolerance but not necessarily requiring a high data rate (e.g., voice traffic, etc.) will have to contend with priority queue 303 traffic for overall access to shared communications medium 302. In this case, the priority traffic not using priority queue 303 that needs to be mixed with priority queue traffic is polled from a central location, in accordance with the illustrative embodiment of the present invention. FIG. 13 depicts access sequences in accordance with the fifth illustrative embodiment of the present invention. Access timing sequence 1301-1 represents the procedure of station 301-1 accessing priority queue 303 on shared communications medium 302. Access timing sequence 1301-2 represents the procedure of station 301-2, acting as hybrid coordinator (i.e., the central location used for polling), accessing shared communications medium 302 in a timely manner. In short, stations 301-1 and 301-2 are vying for contention of some of the same shared resources at the same time. Both sequences start at the time point in time, at which busy medium 503 becomes idle. In well-known fashion, both stations 301-1 and 301-2 carrier-sense at time 505 that shared communications medium 302 has become idle and start timing the interframe space. Station 301-1 seeking access to priority queue 303 waits for interval 506, which can be set equal to the length of the arbitration interframe space (AIFS). In contrast, station 301-2 waits for interframe space 1303, equal to the length of the point interframe space (PIFS), which is shorter than the length of the AIFS used by station 301-1 for the purposes of access priority queue 303. Consequently, station 301-2 gets an advantage over station 301-1 in accessing shared communications medium 302.

Subsequent to waiting interval 506, station 301-1 calculates and then waits the length of its backoff period 508, as previously described. Backoff period 508 can vary in length from one access attempt to another, as represented by the multiple appearances of timeslot 509. At the end of backoff period 508, station 301-1 can transmit priority queue sequence 510, but only if shared communications medium 302 is still idle (i.e., not busy) and if priority queue 303 is accessible. In this example, however, shared communications medium 302 once again becomes busy by the end of backoff window 508.

Meanwhile, on its own timeline and after waiting interframe space 1303, station 301-2 calculates and then waits the length of its backoff period 1305, as calculated by station 301-2. Station 301-2 calculates in well-known fashion the length of backoff period 1305 using the length of contention window 1304 in a randomizing function and the length of timeslot 509. Backoff period 508 can vary in length from one access attempt to another, as represented by the multiple appearances of timeslot 509. The lengths and characteristics of contention window 1304 and backoff period 1305 can be on average the same as or different than the respective lengths and characteristics of contention window 507 and backoff period 508. At the end of backoff period 1305, station 301-2 can initiate polled traffic sequence 1307 with one or more other stations for the purposes of exchanging the polled (e.g., voice, etc.) traffic. Polled traffic sequence 1307 comprises one or more data frames and corresponding ACK frames. Station 301-2 can be part of the actual data frame exchange, or the data frame exchange can involve stations other than station 301-2. It will be clear to those skilled in the art how a hybrid coordinator and associated stations use polling to exchange information.

As depicted in FIG. 13, the polled traffic has priority over the priority queue traffic on shared communications medium 302, since interframe space 1303 is less than interval 506, in accordance with the illustrative embodiment of the present invention.

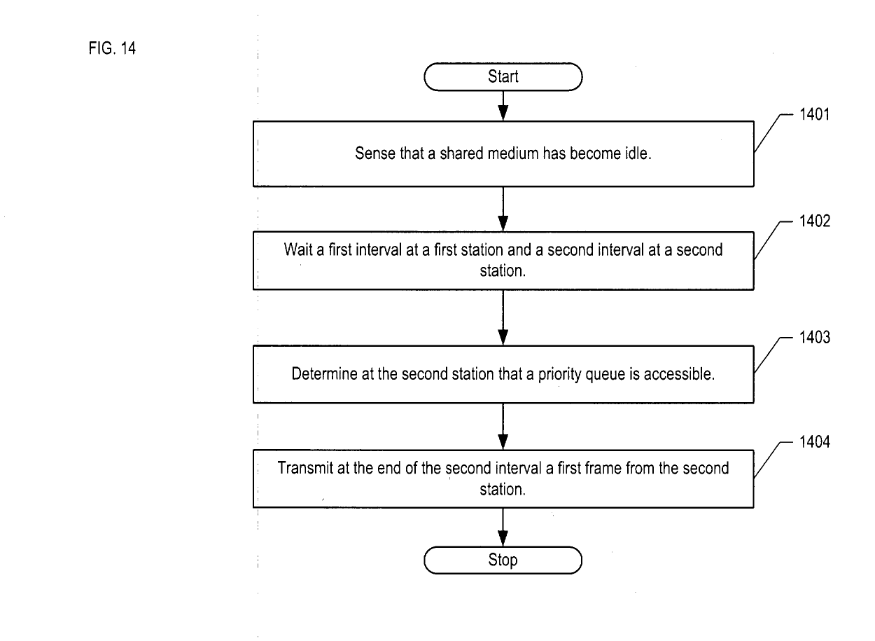

FIG. 14 depicts a flowchart of the tasks performed by station 301-1 in accessing priority queue 303 in accordance with the illustrative embodiment of the present invention. It will be clear to those skilled in the art which of the tasks depicted in FIG. 14 can be performed simultaneously or in a different order than that depicted.

At task 1401, a first station and station 301-1 (i.e., the second station) sense that shared communications medium 302 has become idle. The first station and station 301-1 are both contending for access to shared communications medium 302. It will be clear to those skilled in the art how to sense shared communications medium 302.

At task 1402, station 301-1 seeking access to priority queue 303 waits a second interval and the first station waits a first interval after sensing that shared communications medium 302 has become idle.

At task 1403, station 301-1 determines that priority queue 303 is accessible.

At task 1404, station 301-1 transmits at the end of the second interval a first frame.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method for contending for access to a shared communications medium comprising:
sensing that said shared communications medium has become idle;
waiting a first interval at a first station and a second interval at a second station after said sensing wherein:
(1) said first interval comprises the lengths of a first interframe space and a first backoff period; and
(2) said second interval comprises the lengths of a second interframe space and a second backoff period wherein:
(a) said second interframe space is shorter than said first interframe space; and
(b) said second backoff period is shorter than said first backoff period;
determining at said second station that a priority queue is accessible starting at the end of said second interval; and
transmitting at the end of said second interval a first frame from said second station to a third station after said determining.

2. The method of claim 1 wherein said first frame is a Request_to_Send frame and said third station is at least one of an access point and a hybrid coordinator.

3. The method of claim 2 wherein said Request_to_Send frame specifies a duration that is less than or equal to the calculated time remaining between the end of said Request_to_Send frame and the end of a flow that is to be subsequently communicated using said priority queue, said flow comprising at least one data frame.

4. The method of claim 3 wherein the length of said flow is greater than three milliseconds.

5. The method of claim 3 further comprising:
transmitting a Clear_to_Send frame from said third station to said second station after receiving said Request_to_Send frame; and
transmitting a data frame constituting said flow from said second station to a fourth station after receiving said Clear_to_Send frame.

6. The method of claim 5 wherein said third station and said fourth station are the same.

7. The method of claim 5 wherein said first station, said second station, said third station, and said fourth station constitute an 802.11 network.

8. The method of claim 5 wherein said second station transmits for the second time a data frame constituting said flow after one point interframe space has elapsed without a response to the first transmission of said data frame.

9. The method of claim 1 wherein said second station determines that said priority queue is accessible by:
sending a query to a fourth station; and
receiving, in response to sending said query, an indication from said fourth station that said priority queue is accessible.

10. The method of claim 1 wherein said second station determines that said priority queue is accessible by receiving, in the latest of priority queue accessibility indications transmitted regularly by a fourth station, an indication from said fourth station that said priority queue is accessible.

11. The method of claim 1 wherein said second station determines that said priority queue is accessible by detecting during a third time interval zero frames to be present in said priority queue.

12. The method of claim 1 wherein the length of said second interframe space is equal to the length of a distribution interframe space used by said second station.

13. The method of claim 1 further comprising calculating said second backoff period from a contention window wherein said contention window comprises the characteristic of a CWmin value in the range of 1 to 3, inclusive.

14. The method of claim 1 further comprising calculating said second backoff period from a contention window wherein said contention window comprises the characteristic of a CWmax value being equal to CWmin.

15. The method of claim 1 wherein said second backoff period is in the range of 1 to 3 timeslots.

16. A system comprising:
(1) a first station for:
(a) sensing that a shared communications medium has become idle; and
(b) waiting a first interval after said sensing wherein said first interval comprises the lengths of a first interframe space and a first backoff period;
(2) a second station for:
(a) sensing that said shared communications medium has changed state to idle; and
(b) waiting a second interval after said sensing wherein said second interval comprises the lengths of a second interframe space and a second backoff period wherein:
(i) said second interframe space is shorter than said first interframe space; and
(ii) said second backoff period is shorter than said first backoff period;
(c) determining that a priority queue is accessible starting at the end of said second interval; and
(d) transmitting at end of said second interval a first frame to a third station after said determining; and
(3) said third station for transmitting a second frame to said second station after receiving said first frame.

17. The system of claim 16 wherein said first frame is a Request_to_Send frame and said third station is at least one of an access point and a hybrid coordinator.

18. The system of claim 16 wherein said Request_to_Send frame specifies a duration that is less than or equal to the calculated time remaining between the end of said Request_to_Send frame and the end of a flow that is to be subsequently communicated using said priority queue, said flow comprising at least one data frame.

19. The system of claim 18 wherein the length of said flow is greater than three milliseconds.

20. The system of claim 18 further comprising:
transmitting a Clear_to_Send frame from said third station to said second station after receiving said Request_to_Send frame; and
transmitting a data frame constituting said flow from said second station to a fourth station after receiving said Clear_to_Send frame.

21. The system of claim 20 wherein said third station and said fourth station are the same.

22. The system of claim 20 wherein said first station, said second station, said third station, and said fourth station constitute an 802.11 network.

23. The system of claim 16 further comprising a fourth station for exchanging frames with said third station, wherein said third station:
senses that said shared communications medium has changed state to idle;
waits a third time interval after said sensing wherein said third time interval comprises the lengths of a point interframe space and a third backoff period; and
polls said fourth station to allow said fourth station to transmit a data frame.

24. A first station comprising:
(1) a receiver for:
(a) sensing that a shared communications medium has become idle; and
(b) receiving a Clear_to_Send frame;
(2) a processor for:
(a) waiting a first interval after said sensing wherein said first interval comprises the lengths of an arbitration interframe space and a backoff period wherein:
(i) said arbitration interframe space is equal to the length of a distribution interframe space used by said station; and
(ii) said backoff period comprises a priority bias; and
(b) determining that a priority queue is accessible starting at the end of said first interval; and
(3) a transmitter for:
(a) transmitting a Request_to_Send frame to a second station after said determining and at the end of said first interval; and
(b) transmitting the first frame of a flow after receiving said Clear_to_Send frame.

25. The first station of claim 24 wherein said first station determines that said priority queue is accessible by receiving an indication from said second station that said priority queue is accessible.

26. The first station of claim 24 wherein said first station determines that said priority queue is accessible by detecting during a second time interval zero frames to be present in said priority queue.

27. The first station of claim 24 wherein said priority bias is achieved by calculating said backoff period from a contention window wherein said contention window comprises the characteristic of a CWmin value in the range of 1 to 3, inclusive.

28. The first station of claim 24 wherein said priority bias is achieved by calculating said backoff period from a contention window wherein said contention window comprises the characteristic of a CWmax value being equal to CWmin.

29. The first station of claim 24 wherein said priority bias is achieved by setting said backoff period in the range of 1 to 3 timeslots.
